(19) United States
(12) Patent Application Publication
(10) Pub. No.: US 2025/0240159 A1
(43) Pub. Date: Jul. 24, 2025

(54) OPTIMAL SELECTION OF PROTOCOLS AND TIMESLOTS FOR APPLYING DATA ENCRYPTION

(71) Applicant: Dell Products L.P., Round Rock, TX (US)

(72) Inventors: Ahmed Khalid, Cork (IE); Alan Barnett, Co. Cork (IE); Stephen J. Todd, North Andover, MA (US); Aidan O’Mahony, Cork (IE)

(21) Appl. No.: 18/421,842

(22) Filed: Jan. 24, 2024

(51) Int. Cl. H04L 9/08

(52) U.S. Cl. CPC H04L 9/0891

(57) ABSTRACT

One example method includes receiving a request for performance of a cryptographic task, such as the encryption of data, associating a cryptographic standard and a user policy with the cryptographic task, associating a discretionary factor with the cryptographic task, and selecting, based on the cryptographic standard, the user policy, and the discretionary factor, a cryptographic mechanism to perform the cryptographic task. The discretionary factor may specify a time, or window of time, when the cryptographic task should be performed.

### FIELD OF THE INVENTION

Embodiments of the present invention generally relate to data encryption. More particularly, at least some embodiments of the invention relate to systems, hardware, software, computer-readable media, and methods, for the generation and use of computational efficiency metrics as part of the management of encryption operations.

### BACKGROUND

The current way in which cryptography, such as the encryption of data, is applied is very much focused on policies, management of keys, replacing outdated cipher suites, and other security-focused aspects. Whether the cryptography management application is handled manually or in an as-a-service (aaS) fashion, the focus is solely on the security of the system. Put another way, current encryption management mechanisms only consider security-focused metrics.

In more detail, encryption-as-a-service (EaaS) is a commonly-used term, which can have varying meanings. However, these kinds of management systems are purely focused on abstracting away the complexities of day-to-day management of security systems and providing a streamlined experience to the user.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture according to one embodiment.

FIG. 2 discloses aspects of a mechanism for managing encryption, according to one embodiment.

FIG. 3 discloses a method according to one embodiment.

FIG. 4 discloses a computing entity configured and operable to perform any of the disclosed methods, processes, and operations.

### DETAILED DESCRIPTION OF SOME EXAMPLE EMBODIMENTS

Embodiments of the present invention generally relate to data encryption. More particularly, at least some embodiments of the invention relate to systems, hardware, software, computer-readable media, and methods, for the generation and use of computational efficiency metrics as part of the management of encryption operations.

One example embodiment is directed to a method, which may be implemented by an encryption platform for example, that may comprise the following operations: receiving data for a data encryption task; applying a hierarchy of constraints comprising one or more primary factors such as cryptographic standards, and user policies; evaluating discretionary, also referred to herein as ‘secondary,’ factors to be applied to selection of a data encryption type, such as compute processing availability for encryption, and cost of power needed to perform the encryption; prioritizing as among the discretionary factors; selecting a data encryption type based on the constraints of the hierarchy and based on the discretionary factors; and, applying the data encryption type to encrypt the data.

It is noted that while reference is made herein to data encryption processes performed by an embodiment, the scope of this disclosure extends, more generally, to cryptographic operations, only one example of which is data encryption. Another example of a cryptographic operation is a rekeying process, discussed elsewhere herein.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a layer is provided that enables the consideration of various discretionary factors in the selection and application of an encryption scheme to a group of data. An embodiment may employ a hierarchy of factors, that may comprise a combination of hard constraints, and soft constraints, when determining an encryption scheme to be employed for a group of data. An embodiment is not limited solely to the use of security-based metrics when selecting an encryption scheme. Various other advantages of one or more embodiments will be apparent from this disclosure.

### A. Aspects of an Example Architecture

The following is a discussion of aspects of example architecture for an embodiment of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data encryption operations. An embodiment may be implemented in a cloud-based data protection and storage environment, and data encryption may be provided as-a-Service (asS) to cloud clients. An embodiment may be implemented in an on-prem, local, environment that comprises both the data and the data owner. No particular implementation environment is required however.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

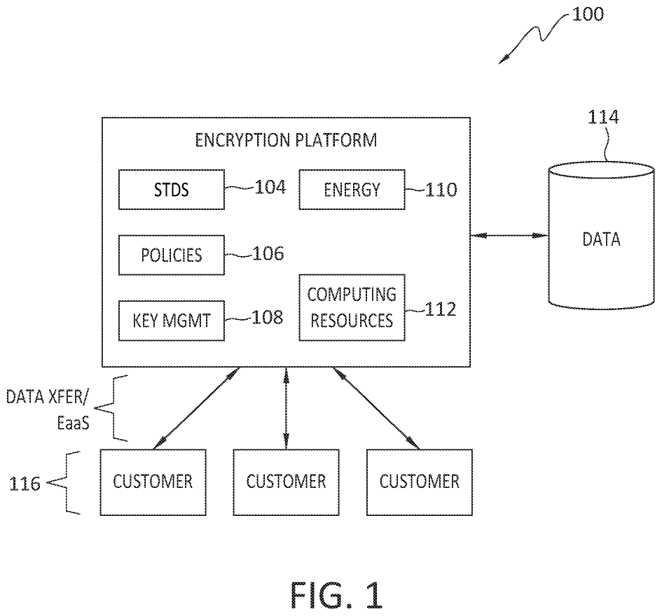

With particular attention now to FIG. 1, one example of an architecture according to one embodiment is denoted generally at 100. As shown, the architecture 100 may comprise an encryption platform 102, which may or may not be hosted at a cloud site. The encryption platform may include various components and information that inform an encryption scheme selection and application process implemented by the encryption platform 102.

For example, the encryption platform 102 may comprise information including encryption standards 104, user policies 106 regarding encryption schemes, and key management functionality and policies 108. As well, the encryption platform 102 may comprise information and guidelines concerning energy consumption 110 by encryption processes, and computing resources 112 requirements for encryption processes.

The encryption platform 102 may comprise, or communicate with, a database 114 that may store encrypted and/or unencrypted data. Data to be encrypted by the encryption platform 102 may be received from one or more customers 116. In an embodiment, encryption services provided by the encryption platform 102 with respect to the customer data may be provided by the encryption platform as Encryption-as-a-Service (EaaS), but that is not required in any embodiment.

### B. Aspects of an Example Encryption Selection Approach

### B.1 Overview of Aspects of an Embodiment

An embodiment may serve to expand on approaches that rely solely on security-based metrics to select and implement encryption processes. For example, an embodiment may add a layer which also considers efficiency and appropriateness of various cryptographic mechanisms, candidate cipher suites and cryptographic modes of operation for given tasks.

In an embodiment a selection process would be constrained by crypto-standards/user policies, but otherwise makes decisions of selecting and/or applying cryptography. An embodiment of this mechanism may provide users the ability to time computationally expensive cryptographic operations, such as by using pre-migration encryption to encrypt data before it is migrated to a target, dynamically to take advantage of lower energy prices.

An embodiment may provide benefits to cryptographic key management, for example where cryptographic keys will soon expire, a rekeying process could be completed slightly earlier than planned if energy, such as electrical power for example, becomes available at cheaper prices. An embodiment may also consider the available of computing resources for performing encryption.

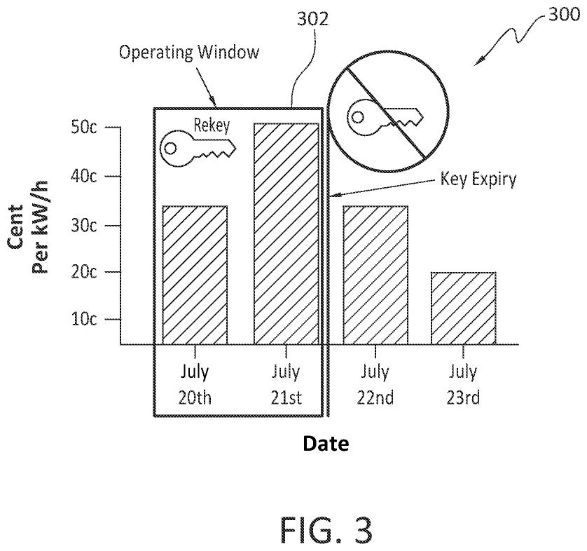

In an embodiment, the level of flexibility in exploiting pricing opportunities, or computational availability may first be constrained by cryptography standards—for example, the standard may provide that rekeying should never be delayed simply to save money—and, secondly by user policies—for example, a user may specify that a reduction in cost is less important than the speed with which the encryption process can be performed. For example, the date on which a user desires an encryption operation to be carried out could instead be seen as the closing date for a window in which an embodiment may select an optimum time to carry out the operation. An example of this approach is disclosed in FIG. 3, discussed below.

### B.2 Detailed Discussion of Aspects of an Embodiment

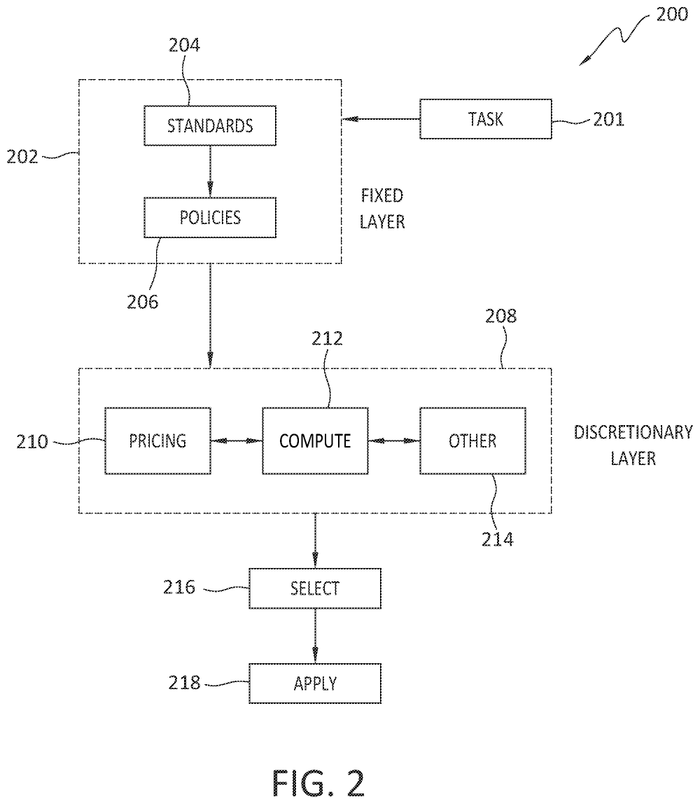

With reference now to FIG. 2, one example mechanism 200 for selection of an encryption process to be applied to a group of data for a particular encryption task 201 is disclosed. As shown in FIG. 2, the mechanism 200 may, in one embodiment, be considered as comprising, and/or being implemented as, a layer structure. The layers may, in turn, collectively define a hierarchy that may comprise one or more sub-hierarchies.

In the example of FIG. 2, a top-most layer of a hierarchy may comprise a fixed layer 202 that includes one or more items which may be considered as hard constraints. That is, those items are non-negotiable and mandatory for consideration when selecting an encryption scheme. One such item is a set of one or more cryptographic standards 204, examples of which may include, but are not limited to, the NIST FIPS (National Institute of Standards and Technology—Federal Information Processing Standards), AES (advanced encryption standard), RSA (Rivest-Shamir-Adleman), OpenPGP, Lightweight Cryptography (LWC), Message Authentication Codes (MACs), Multi-Party Threshold Cryptography, Post-quantum Cryptography (PQC), Privacy-Enhancing Cryptography (PEC), and Random Bit Generation.

In addition to the cryptographic standards 204, the fixed layer 202 may comprise various policies 206, such as may be promulgated by a business entity or other data owner, governmental agency, or NGO (non-governmental organization). The cryptographic standards 204 and policies 206 may vary according to the nature of the data owner, the data involved, and various other considerations. Various combinations of cryptographic standards 204 and policies 206 may be defined to suit particular circumstances.

Below the fixed layer 202, the example hierarchy 200 may comprise a discretionary layer 208 that may comprise or define various other items, which may be considered as soft constraints. That is, those items are negotiable and may be modified, or dispensed with completely, when selecting an encryption scheme. One such item is denoted as pricing 210. In an embodiment, pricing information 210 may comprise information as to the cost involved in performing a particular encryption process. The cost may be derived based on the amount of time expected to be need for performing the encryption process and/or the amount of resources, such as processing, expected to be consumed in performing the encryption process.

The cost to perform an encryption process may vary at different times. For example, electrical power, or other energy sources, may be relatively less expensive in evenings when demand is low, and relatively more expensive in mornings and daytime when demand is higher.

In some instances, the pricing information 210 may be irrelevant, for example, if a large amount of important data must be encrypted in a relatively short period of time to head off a possible attack by a bad actor, the primary consideration may be the speed with which the encryption can be performed, regardless of the cost, particularly if the cost of lost or compromised data would be greater than the cost to encrypt.

Another example item that may be included in the discretionary layer 208 is compute requirements information 212. Compute requirements may embrace, but is not limited to, the resource requirements expected to be needed to perform an encryption operation for a group of data. Such resources may include, but are not limited to, memory, storage, processing, and transmission/reception bandwidth. The compute requirements information 212 may be used as a basis for searching a network or other environment to determine what resources are available, and to what extent.

Note that the discretionary layer 208 may incorporate a hierarchy, which may a sub-hierarch of that which comprises the fixed layer 202 and the discretionary layer 208. For example, it may be the case that compute requirements are more important in the selection of an encryption scheme than are pricing or cost considerations. In such a case, a decision might be made to select the encryption scheme based on compute requirements and, as among two encryption schemes with the same/similar compute requirements, the cost to perform the encryption may be used as a ‘tie-breaker’ as between the two encryption schemes.

Finally, the discretionary layer 208 may include various other information 214 that may or may not be considered in the selection of an encryption scheme. It is noted that while the discretionary layer 208, and its information, may exist and be available, they may be bypassed in some circumstances so that an encryption scheme is selected based only on standards 204, and policies 206.

When the various hard and soft constraints have been specified, an encryption scheme that meets the constraints may then be selected as part of a selection process 216. The selected encryption scheme can then be applied 218. As part of the selection process and/or the application process, feedback may be gathered that may be used to guide future such processes. For example, if the application of the encryption process meets the applicable constraints but is technically complex, a better approach may be to select a process that is relatively less complicated to implement.

### B.3 Key Expiry Example Use Case

With reference now to FIG. 3, one example of a cryptographic operation according to an embodiment is disclosed. In this illustrative example, the cryptographic operation comprises a rekeying operation. In an embodiment, a rekeying operation may comprise changing a session key, or other key, to limit the time for which the key is effective and, correspondingly, to limit an amount of data encrypted using that key. That is, a rekeying operation may comprise setting a time window during which, and only during which, a key is usable to encrypt data. When the key expires, it is no longer usable to encrypt data. As explained in the example below, the rekeying operation may be performed in a way that takes into account one or more constraints, one example of which is the cost of the energy expected to be needed to performing the rekeying operation.

In the illustrative, and non-limiting, example of FIG. 3, a graph 300 is shown that includes a Y-axis for energy cost, expressed here as cents per kW/h, and the X-axis for the date. In this example, the date on which a user desires a cryptographic operation, such as a rekeying operation, to be carried out may be considered as the closing date for a window in which an embodiment may select an optimum time to carry out the cryptographic operation.

In more detail, a window 302 may be defined during which the rekeying operation is to be performed, and after the end of which, the key is no longer effective to encrypt data. Thus, in this example, the rekeying window opens at the beginning of the day on July 20, and closes at the end of the day on July 21. Thus, the rekeying operation may be performed any time during the window 302, but no later than the end of the day on July 21.

However, as shown in the graph 300, energy is relatively less expensive on July 20, about 35 cents per kW/h, than on July 21, about 50 cents per kW/h. Since both time periods are within the window 302, an embodiment may choose to perform the rekeying operation, which may be an energy-intensive process that consumes a non-trivial amount of power, sometime during the day of July 20. In this way the, an embodiment may perform a cryptographic operation guided not only by established cryptographic standards and user policies, but also by one or more secondary considerations, such as the cost of energy in this example.

### C. Example Methods

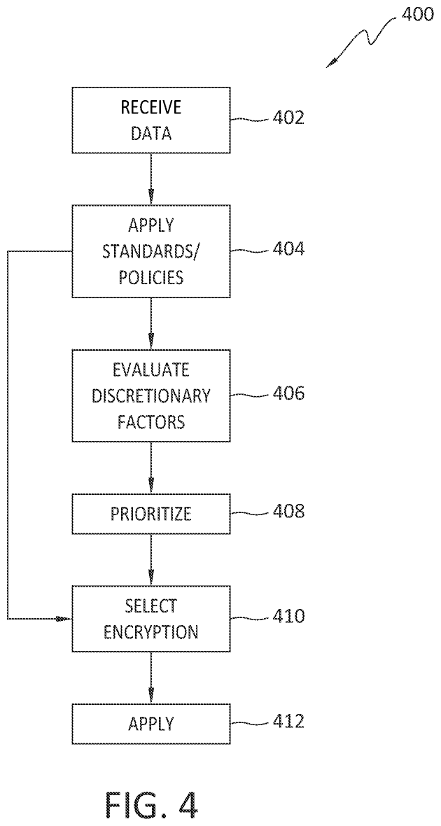

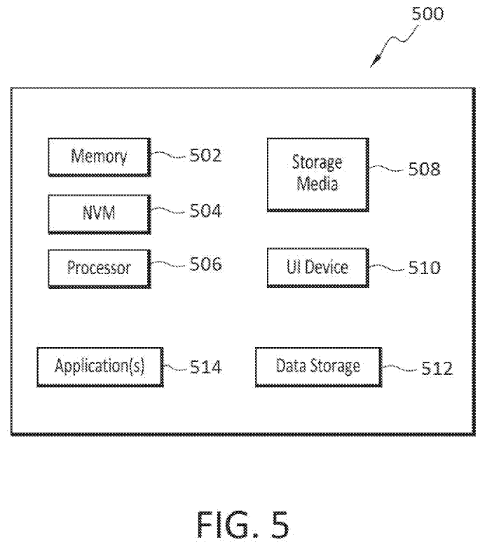

It is noted with respect to the disclosed methods, including the example method of FIG. 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 4, a method according to one embodiment is referenced at 400. The example method 400, which may be performed in whole or in part by an encryption platform, may involve performance of a task that comprises a cryptographic operation, such as the encryption of data.

Thus, the method 400 may begin when an encryption platform receives 402 data, such as customer data, for encryption. Next, any relevant cryptographic standards and/or user policies may be applied 404. This operation 404 may thus prevent the selection of a cryptographic mechanism that is inconsistent in some way with the cryptographic standards and/or user policies.

In addition to the application 404 of relevant cryptographic standards and/or user policies, the method 400 may also comprise the evaluating 406 of one or more discretionary factors to be applied to the selection of a cryptographic mechanism. These discretionary factors may not be required for the selection of a cryptographic mechanism, but when used may provide for a more granular approach to the selection of a cryptographic mechanism, rather than simply selecting a cryptographic mechanism based solely on relevant cryptographic standards and/or user policies.

Depending upon the type and number of discretionary factors to be applied, a prioritization operation 408 may be performed as among those discretionary factors. Thus, the discretionary factors, where there are more than one, may, or may not, be mutually exclusive. In one embodiment, the prioritization operation 408 may identify, from among the discretionary factors, which is to be given the greatest weight with respect to selection of a cryptographic mechanism to be applied to a group of data. In an embodiment, a subset of all the available discretionary factors may be used to inform the selection of an encryption mechanism.

When the cryptographic standards and/or user policies, and any discretionary factors, have been identified and taken into account, a cryptographic mechanism may be selected 410 that meets those constraints. It is noted that, in an embodiment, the operations 406 and 408 may be omitted, and the method 400 may proceed from the operation 404 directly to the operation 410. Finally, the selected 410 encryption mechanism may be applied 412 to encrypt the data specified in the task.

### D. Further Example Embodiments

Following are some further example embodiments of the invention. These are presented only by way of example and are not intended to limit the scope of the invention in any way.
Embodiment 1. A method, comprising: receiving a request for performance of a cryptographic task; associating a cryptographic standard and a user policy with the cryptographic task; associating a discretionary factor with the cryptographic task; and selecting, based on the cryptographic standard, the user policy, and the discretionary factor, a cryptographic mechanism to perform the cryptographic task.
Embodiment 2. The method as recited in any preceding embodiment, wherein the cryptographic task comprises encryption of a group of data.
Embodiment 3. The method as recited in any preceding embodiment, wherein the cryptographic task comprises a rekeying operation.
Embodiment 4. The method as recited in any preceding embodiment, wherein the cryptographic mechanism comprises a mechanism for encrypting data identified in the cryptographic task.
Embodiment 5. The method as recited in any preceding embodiment, wherein the discretionary factor comprises any one or more of: expected energy consumption associated with performance of the cryptographic task; and expected availability of one or more computing resources for performance of the cryptographic task.
Embodiment 6. The method as recited in any preceding embodiment, further comprising using the cryptographic mechanism to perform the cryptographic task.
Embodiment 7. The method as recited in any preceding embodiment, wherein the receiving the request, the associating the cryptographic standard and the user policy, the associating the discretionary factor, and the selecting, are all performed and provided as-a-service to a customer from which the request was received.
Embodiment 8. The method as recited in any preceding embodiment, wherein the discretionary factor comprises expected energy consumption associated with performance of the cryptographic task, and the discretionary factor indicates first and second time periods when the energy is relatively less, and more, expensive.
Embodiment 9. The method as recited in any preceding embodiment, wherein the discretionary factor enables a user to select a time, or a window of time, when the cryptographic task will be performed.
Embodiment 10. The method as recited in any preceding embodiment, wherein the cryptographic task is performed at a time when energy needed to perform the cryptographic task is less expensive than a cost of that energy at a different time, and/or the cryptographic task is performed at a time when adequate computing resources to perform the cryptographic task are available.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the methods, processes, and operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a request for performance of a cryptographic task;
associating a cryptographic standard and a user policy with the cryptographic task;
associating a discretionary factor with the cryptographic task; and
selecting, based on the cryptographic standard, the user policy, and the discretionary factor, a cryptographic mechanism to perform the cryptographic task.

2. The method as recited in claim 1, wherein the cryptographic task comprises encryption of a group of data.

3. The method as recited in claim 1, wherein the cryptographic task comprises a rekeying operation.

4. The method as recited in claim 1, wherein the cryptographic mechanism comprises a mechanism for encrypting data identified in the cryptographic task.

5. The method as recited in claim 1, wherein the discretionary factor comprises any one or more of: expected energy consumption associated with performance of the cryptographic task; and expected availability of one or more computing resources for performance of the cryptographic task.

6. The method as recited in claim 1, further comprising using the cryptographic mechanism to perform the cryptographic task.

7. The method as recited in claim 1, wherein the receiving the request, the associating the cryptographic standard and the user policy, the associating the discretionary factor, and the selecting, are all performed and provided as-a-service to a customer from which the request was received.

8. The method as recited in claim 1, wherein the discretionary factor comprises expected energy consumption associated with performance of the cryptographic task, and the discretionary factor indicates first and second time periods when the energy is relatively less, and more, expensive.

9. The method as recited in claim 1, wherein the discretionary factor enables a user to select a time, or a window of time, when the cryptographic task will be performed.

10. The method as recited in claim 1, wherein the cryptographic task is performed at a time when energy needed to perform the cryptographic task is less expensive than a cost of that energy at a different time, and/or the cryptographic task is performed at a time when adequate computing resources to perform the cryptographic task are available.

11. A non-transitory storage medium having stored therein instructions that are executable by one or more hardware processors to perform operations comprising:
receiving a request for performance of a cryptographic task;
associating a cryptographic standard and a user policy with the cryptographic task;
associating a discretionary factor with the cryptographic task; and
selecting, based on the cryptographic standard, the user policy, and the discretionary factor, a cryptographic mechanism to perform the cryptographic task.

12. The non-transitory storage medium as recited in claim 11, wherein the cryptographic task comprises encryption of a group of data.

13. The non-transitory storage medium as recited in claim 11, wherein the cryptographic task comprises a rekeying operation.

14. The non-transitory storage medium as recited in claim 11, wherein the cryptographic mechanism comprises a mechanism for encrypting data identified in the cryptographic task.

15. The non-transitory storage medium as recited in claim 11, wherein the discretionary factor comprises any one or more of: expected energy consumption associated with performance of the cryptographic task; and expected availability of one or more computing resources for performance of the cryptographic task.

16. The non-transitory storage medium as recited in claim 11, further comprising using the cryptographic mechanism to perform the cryptographic task.

17. The non-transitory storage medium as recited in claim 11, wherein the receiving the request, the associating the cryptographic standard and the user policy, the associating the discretionary factor, and the selecting, are all performed and provided as-a-service to a customer from which the request was received.

18. The non-transitory storage medium as recited in claim 11, wherein the discretionary factor comprises expected energy consumption associated with performance of the cryptographic task, and the discretionary factor indicates first and second time periods when the energy is relatively less, and more, expensive.

19. The non-transitory storage medium as recited in claim 11, wherein the discretionary factor enables a user to select a time, or a window of time, when the cryptographic task will be performed.

20. The non-transitory storage medium as recited in claim 11, wherein the cryptographic task is performed at a time when energy needed to perform the cryptographic task is less expensive than a cost of that energy at a different time, and/or the cryptographic task is performed at a time when adequate computing resources to perform the cryptographic task are available.
